(19) United States
(12) Patent Application Publication
(10) Pub. No.: US 2004/0075627 A1
(43) Pub. Date: Apr. 22, 2004

(54) Image display device

(75) Inventors: Takayuki Ouchi, Tokyo (JP); Yoshihiro Mikami, Tokyo (JP); Hajime Akimoto, Tokyo (JP); Toshihiro Sato, Tokyo (JP)

Correspondence Address: HOGAN & HARTSON L.L.P., 500 S. GRAND AVENUE, SUITE 1900, LOS ANGELES, CA, 90071-2611, US

(73) Assignee: HITACHI DISPLAYS, LTD.

(21) Appl. No.: 10/643,776

(22) Filed: Aug. 19, 2003

(30) Foreign Application Priority Data
Sep. 20, 2002 (JP) 2002-274259

(51) Int. Cl. G09G 3/30

(52) U.S. Cl. 345/76

(57) ABSTRACT

An image display device comprising a current-driven electro optic display element in which a plurality of picture elements has a light-emitting layer that has a transparent picture element electrode and a metal picture element electrode therebetween, wherein each picture element has a driving circuit which is connected to a vertical scanning circuit that includes a sequential circuit through a scanning wire and to a horizontal driver through a data wire and either one of above two electrodes is connected to a wire placed in parallel to said scanning wire and a terminal of said wire is, through a switching device, selectively connected to an electric power source that gives an electric potential for the purpose of applying a voltage necessary to drive the above optic display element or to another electric power source that gives an electric potential of which polarity is reverse to a voltage applied in emitting operation.

### FIELD OF THE INVENTION

This invention relates to an image display device, more specifically, an image display device of active matrix type that has electro-luminescence (abbreviated as “EL”, hereinafter) elements formed on the substrate and offers the technology by which the EL operation life can be extended in use for such image display devices.

### BACKGROUND OF THE INVENTION

In recent years, a market demand for personal computers, portable information devices, communication devices and complex products having such relevant technologies has been increasing. For these devices and products, a display device that has characteristics that features thinness, lightness and high-speed response is preferable and a self luminescent organic LED (abbreviated as “OLED”, hereinafter) device has been applied to image display devices in accordance to such market demand.

An example of the system block diagram and the circuit diagram of the picture element used for conventional image display devices is shown in FIG. 8. As shown in FIG. 8, the first thin film transistor (abbreviated as TFT, hereinafter) Tsw16 is connected at each cross point of scanning wires 11 and data wires 12, wherein a data holding capacitor Cs15 and TFT17 which is the second TFT (Tdr17) to control the current supplied to OLED25 are connected to Tsw16. TFT 17 is connected to a transparent anode for the EL layer through an insulating layer.

The two electrodes of the OLED devices have a construction such that one of the electrodes is directly connected to a common power wire and the other electrode is connected to the other common power wire through Tdr17, that is the second TFT. Therefore, it is not possible to specifically control the bias voltage of a particular transistor formed in the whole display.

As it will be explained later, there is a scheme to drive the active matrix display by a digital operation while the reverse bias voltage, as seen in the following;

Reference 1

Japanese Patent Publication Number 2001-222255

One of the problems in realizing the image display that uses OLED devices is the short life time of the OLED devices due to OLED characteristic degradation in the operation. The major factors to affect the life time are remarked as the construction of the device that drives the OLED display, the characteristics of organic EL material that composes the OLED devices, the electrode material, process conditions for the fabrication.

Besides these factors, the driving scheme of the OLED display is notified as another remarkably affecting factor for the life time of the EL layer used in the OLED display.

The conventional method to generate the light emission by driving the OLED device has been carried out by applying the DC voltage between the two electrodes and making current flow in the EL layer. For this DC voltage applied, the holes and electrons injected into the EL layer are transported to the emission layer where the holes and the electrons are combined and the energy of the combination is emitted as light emission. However, the EL layer has an electrically insulating property under the voltage being applied. Therefore the holes and electrons that have not been combined remain in the layer. These carriers are stored in the EL layer as they remain and considered to affect to shorten the life time of the EL devices. As one of the solution for this problem, a voltage with a reversed polarity against the normal voltage applied in emission term is applied in order to purge the electric charge due to the remaining holes and electrons.

However, it is necessary to clearly segregate two terms with out overlapping as the term for light emitting and the term to apply the reverse voltage. As a result, the occupation rate of the light emitting term decreases to a frame term. To maintain the same amount of the light emission in a frame term, it is necessary to increase the peak intensity of the light emission that gives a serious drive condition of the OLED devices and results in a negative affect to the life time of the OLED devices.

For the active matrix panel as shown in FIG. 8, for example, in case that the one address (data WRITE) scanning 60 and the presentation (TURN-ON) term 61 can be segregated in one frame, the emission term for each wire is the time of the frame term T1v subtracted with the address term T1h, that is, T1v-T1h, when no reverse bias applying term 64 is set. In case that the term to apply the reverse voltage is incorporated for the frame term, the term to allocate in the frame term is shown as in FIG. 9 since the emission term and the term to apply the reverse voltage cannot be controlled for each wire due to the fact that the electric power supply terminal of the electrical source that settles the bias status of the OLED device is commonly connected to all of the picture elements.

In FIG. 9, the vertical axis shows the position of the scanning wire of which number is from “1” to “m” in order and the horizontal axis the time on which the scanning is based. The non-presentation (TURN-OFF) term 63 is the term subtracted the presentation term 61, data WRITE scanning 60 and TURN-OFF scanning 62 from one frame term T1v. However, since the actual term for applying the reverse bias voltage for the whole panel can only be the reverse bias applying term 64 which does not overlap with the address term, about a half of the non-presentation term 63 is an irrelevant term to the presentation term 61 or reverse bias applying term 64, which causes for lessening the emission efficiency.

As a similar technology such as a scheme to drive the active matrix display by a digital operation while the reverse bias voltage is applied shown in Japanese Patent Publication Number 2001-222255, reverse bias applying method, in which the polarity of the applied voltage to EL element is reversed for each frame, has been proposed. Since the normal voltage applying is carried out for every two frames, the EL element emits the light once for every two frames. Therefore, 120 Hz frame rate which is more than twice of the conventional one is selected. In order to maintain the same amount of the light emission in average, it is necessary to increase the peak intensity of the light emission and operate the EL elements in a serious drive condition.

As described above, an effective driving method has been required for the active matrix display using EL elements such that the term subtracted the reverse bias applying term from the frame term is used for the emission term in order to extend the life time of EL elements.

### SUMMARY OF INVENTION

The objective of this invention is to provide an image display device that has a long term life by obtaining effectively long emission term and lessen emission peak of the EL elements in a frame operation.

An aspect of the present invention is given as an image display device that comprises an electric current-driven electro optic display element and a drive circuit to control the driving current supplied to the electro optic display element on a substrate on which a plurality of picture elements is aligned in a form of a matrix wherein each picture element has a light-emitting layer that has a transparent picture element electrode and a metal picture element electrode therebetween to compose of the electric current-driven electro optic display element, wherein each picture element has a driving circuit which is connected to a vertical scanning circuit that includes a sequential circuit through a scanning wire and to a horizontal driver through a data wire, either the transparent picture element electrode or the metal picture element electrode is directly or, through a driving device, connected to a wire placed in parallel to the scanning wire in each location of the picture element and a terminal of the wire is, through a switching device, selectively connected to an electric power source that gives an electric potential for the purpose of applying the voltage necessary to drive the electric current-driven electro optic display element or another electric power source that gives an electric potential of which polarity is reverse to the voltage applied in emitting operation.

In this circuit system, it is possible to independently switch to the emission term or the reverse bias applying term which is non-emission term, therefore it is possible to extend the emission term long enough within a limit of the frame term so that the long life of the image display device can be obtained.

Another aspect of this invention is that the switching device has switching operation by using a sequential circuit that has the same scanning direction as that of the vertical scanning circuit.

Another aspect of this invention is that the switching device has switching operation by using the signal generated by the sequential circuit built in the vertical scanning circuit.

Either the transparent picture element electrode or the metal picture element electrode is directly or, through the driving device, connected to the wire placed.

Another aspect of this invention is that switching device has switching operation by using a sequential circuit that has the same scanning direction as that of the vertical scanning circuit and either the transparent picture element electrode or the metal picture element electrode is directly or, through a driving device, connected to the wire.

Another aspect of this invention is that the switching device has switching operation by using the signal generated by the sequential circuit built in the vertical scanning circuit and either the transparent picture element electrode or the metal picture element electrode is directly or, through the driving device, connected to the wire.

Either the transparent picture element electrode or the metal picture element electrode is connected to a wire within each picture element.

Another aspect of the present invention is given as an image display device that comprises an electric current-driven electro optic display element and a drive circuit to control the driving current supplied to the electro optic display element on a substrate on which a plurality of picture elements is aligned in a form of a matrix wherein each picture element has a light-emitting layer that has a transparent picture element electrode and a metal picture element electrode therebetween to compose of the electric current-driven electro optic display element, wherein each picture element has a driving circuit which is connected to a vertical scanning circuit that includes a sequential circuit through a scanning wire and to a horizontal driver through a data wire and either the transparent picture element electrode or the metal picture element electrode has a switching device within the picture element of which the switching device has a function to selectively switch-on to a current source or to an electric power source that gives an electric potential which has a reverse polarity of a voltage necessary to drive the electric current-driven electro optic display element in emitting operation.

This circuit system realizes the same effect as the previous aspect of the present invention.

Another aspect of the present invention is given as an image display device that comprises a plurality of scanning wires that are distributively laid over an image display area therein and that transmit a scanning signal therethrough, a plurality of data wires that are laid over the image display area with crossing over the plurality of the scanning wires and that transmit a signal voltage therethrough, a plurality of electric current-driven electro optic display elements of which each element is laid in each of picture element areas surrounded by the scanning wire and the data wire and connected to a common electric power supply, a plurality of driving devices that are connected to the electric current-driven electro optic display elements in series and to a common electric power supply and that activate the electric current-driven electro optic display elements for emission by applying bias voltage thereto, and a plurality of memory control circuits that hold the signal voltage in response to the scanning signal and control a driving operation of the driving devices by using the signal voltage, wherein the memory control circuit holds a signal voltage obtained by a signal sampling with blocking the bias voltage applied to the driving device while the electric current-driven electro optic display elements are kept in a voltage status for non-emission and the signal voltage is applied to the driving device as the bias voltage thereafter.

In addition, another aspect of the present invention is an image display device described above, wherein the scanning signal is used for the control signal that changes the bias voltage applied to the electric current-driven electro optic display elements in a switching manner.

In this construction of the circuitry, the same effect of the aspect described above can be obtained.

### BRIEF DESCRIPTION OF THE DRAWINGS

FIG. 1 is a diagram that shows a whole lay out of an image display device regarding to the first embodiment.

FIG. 2 is a timing chart that shows the operation of the image display device regarding to the first embodiment.

FIG. 3 is a diagram that shows a whole lay out of an image display device regarding to the second embodiment.

FIG. 4 is a circuit diagram of a picture element regarding to the third embodiment.

FIG. 5 is an example of a layout pattern of a picture element regarding to the third embodiment.

FIG. 6 is a circuit diagram of a picture element regarding to the fourth embodiment.

FIG. 7 is a diagram that shows a whole lay out of an image display device regarding to the fifth embodiment.

FIG. 8 is a circuit diagram of a picture element regarding to the conventional image display devices.

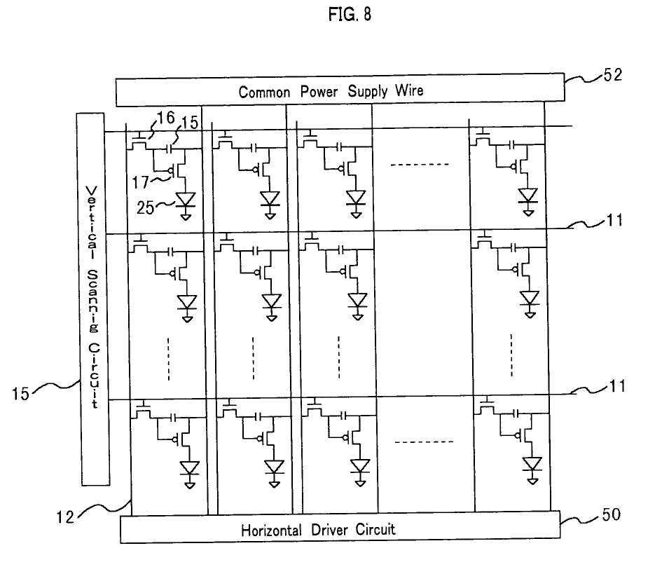

FIG. 9 is a timing chart that shows the operation of the image display device regarding to the conventional image display device.

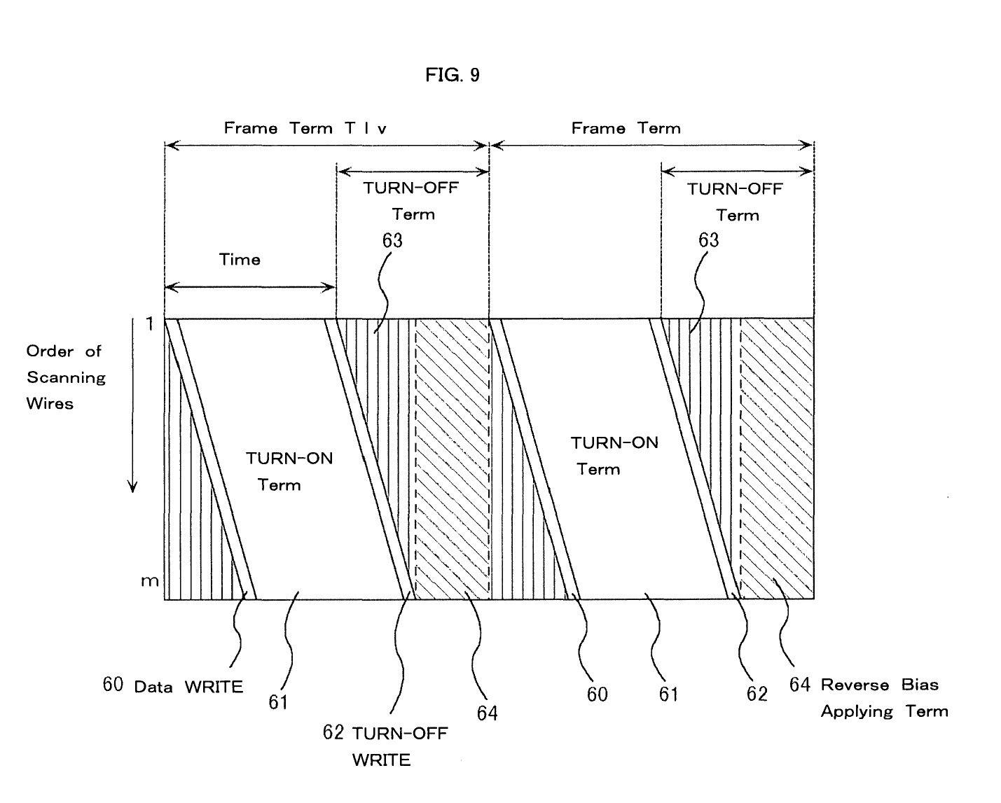

FIG. 10 a diagram that shows a whole lay out of the present invention (the third embodiment).

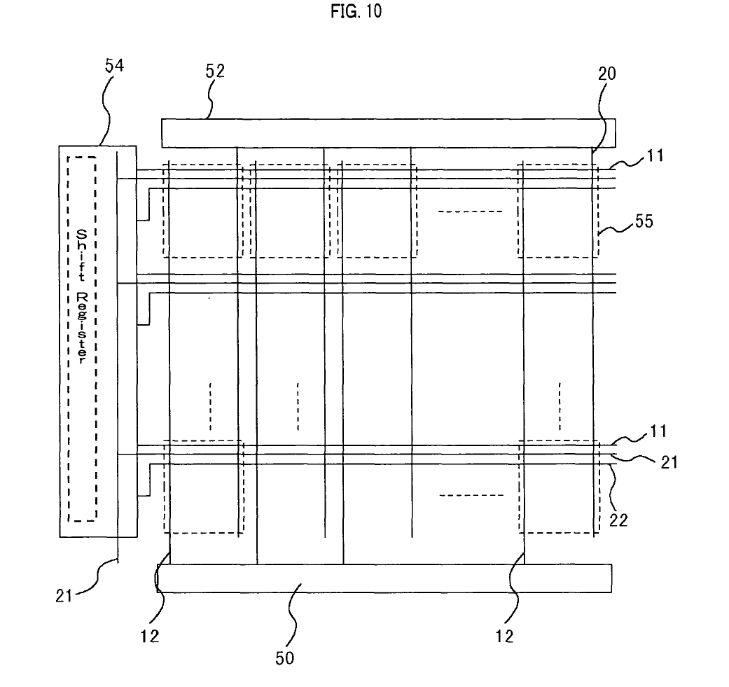

### DETAILED DESCRIPTION OF THE INVENTION

A plurality of embodiments regarding this invention will be explained in details.

The First Embodiment

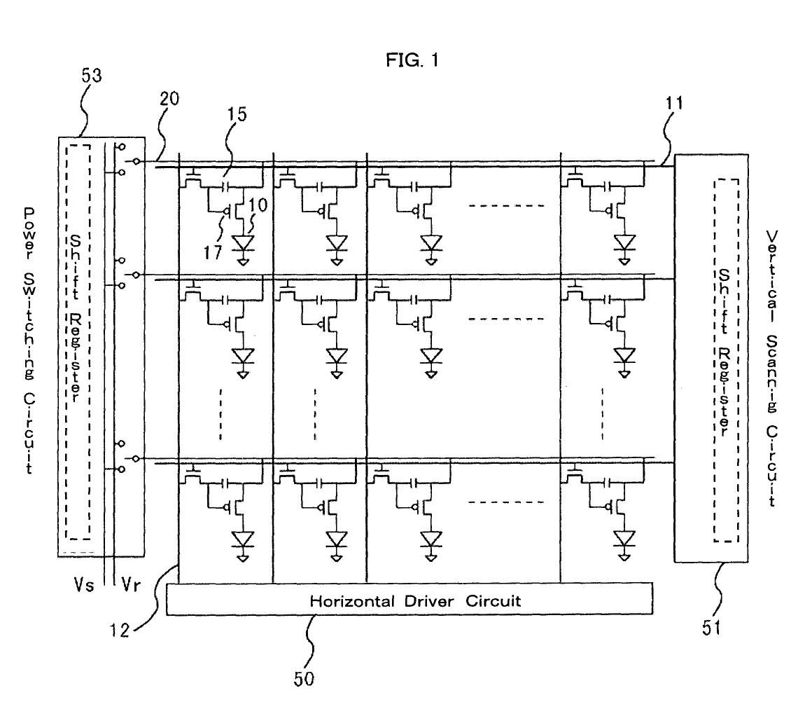

FIG. 1 shows the subjective part of the image display devices regarding to the first embodiment of the present invention.

A plurality of scanning wires 11 and a plurality of electric current supply wire 20 are alternatively laid and the wires are connected to a vertical scanning circuit 51 including a sequential circuit and a power switching circuit 53, respectively, at the terminal thereof. A plurality of data wires 12 are laid in vertical direction and an image signal is sent to the data wires 12 from a horizontal driver 50. Picture elements are formed in a formation of matrix on the areas where the scanning wires 11 and the electric current supply wires 20 are crossing over the data wires 12. Signal voltage is held at a data holding capacitor 15 placed in picture elements selected by the scanning wires and electric current regulated by the second TFT Tdr17 which is under control by the signal voltage is applied is supplied to each display element which is activated for emission.

The electric current supply wires 20 are, at the terminals of the wires, connected to the power switching circuit 53 which includes a shift register as a sequential circuit. By using the signal generated by the shift register, it is possible to switches to the voltage Vs which activates the display element in emission by applying the voltage of the current supply wire 20 that works as a forward bias thereof or the voltage Vr which gives a reverse voltage to the display element.

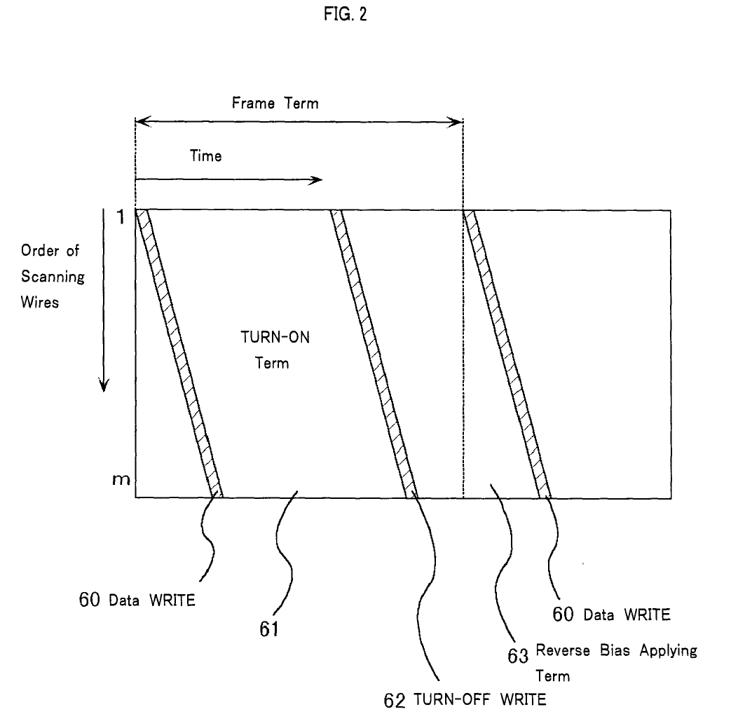

FIG. 2 is the timing chart that shows the display operation using the image display device shown in FIG. 1.

In FIG. 2, the horizontal axis shows time and the vertical axis corresponds to each the location of the scanning wire on the surface of display device. The data WRITE (address) 60 starts from the first canning wire locating in the top of display device towards the last scanning wire locating in the bottom thereof and each wire turns into the presentation term and the picture elements connected to each scanning wire turn into the address term after the end of presentation term in which TURN-OFF scanning is carried out.

In this TRUN-OFF scanning term, the voltage of electric current supply wire 20 is switched to change from Vs to Vr by scanning the shift register built-in the power switching circuit 53 and the picture elements connected to the scanning wires turn into reverse bias applying term (TURN-OFF term) 63 in a sequential order. When the next frame starts again, the address term (data WRITE scanning 60) starts to write data again, the picture elements connected to each scanning wire turn into the presentation term 60 by changing the voltage of the electric current supply wire from Vr to Vs in scanning power switching circuit.

By using this driving scheme, each electric current supply wire is segregated the frame term into the presentation term and the reverse bias applying term, therefore there is no non-operating term so that the emission term can be obtained relatively long in the frame term that does not require high-peak emission and long operation life of the OLED devices is realized by lessening the peak current supplied to OLED devices.

The Second Embodiment

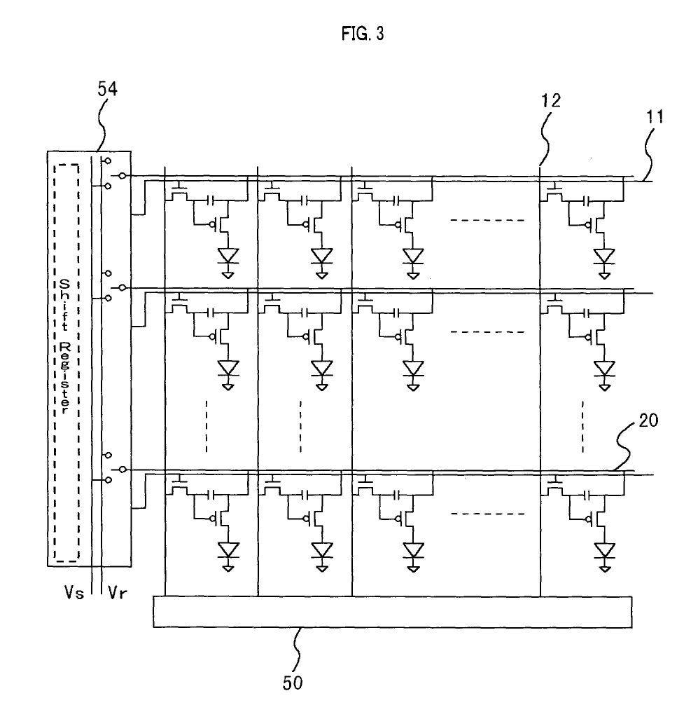

FIG. 3 shows the block diagram of an image display device regarding to the second embodiment of the present invention.

The difference from the first embodiment is that the power switching circuit 53 and the vertical scanning circuit 51 are consolidated into a control circuit 54 and a common shift register is used for both power switching circuit functionality and the vertical scanning circuit functionality. In this embodiment, the scale of circuitry has been confined into a compact scale and the power consumption can be reduced.

In the first and second embodiments, the picture element circuit consists of two TFTs as shown in FIG. 1. However, the present invention is not confined in such a circuit configuration. In other words, it is obvious that the picture element circuit can be constructed with TFTs more than two as shown in FIG. 1 as far as the circuit system can apply the voltage to the OLED devices 10 in a manner of vertical scanning switching.

The Third Embodiment

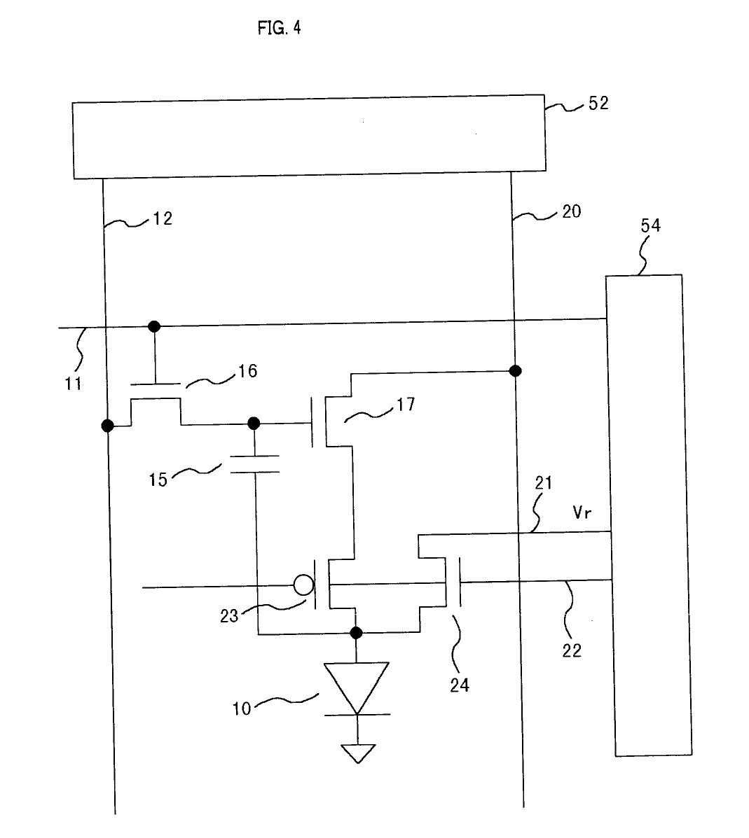

FIG. 4 shows the circuit diagram of the image display device in the third embodiment.

The differences from the first and the second embodiments are that the electric current supply wire 20 is aligned in parallel to the data wire 12 and connected to the common power supply wire 52 and that a reverse applied voltage Vr supply wire 21 and bias voltage switching control wire 22 are aligned in parallel to the scanning wire 11 and connected to a control circuit 54.

Since the bias condition to the OLED devices can be controlled by the bias voltage switching control wire 22 in this circuitry, it is possible to change the switched state as TURN-ON/TURN-OFF regarding each raw of the picture elements connected to a bias voltage switching control wire 22 in a single frame term. Therefore the whole TRUN-OFF term can be exploited to the reverse bias applying term.

In addition, since the same shift resister circuit is used for the control circuit 54, it is possible that the scale of circuitry is confined into a compact scale, the power consumption is reduced and productivity can be increased by improving the production yield.

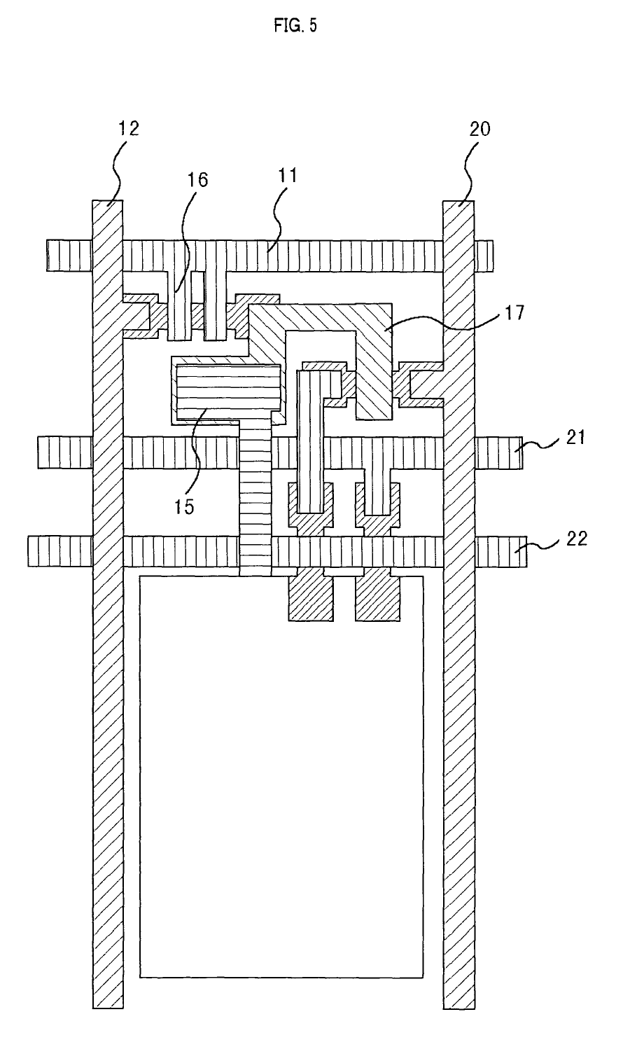

FIG. 5 shows an example of the layout pattern for the circuit diagram shown in FIG. 4

The first TFT Tsw16 for bias switching is formed in a dual gated MOS transistor in order to suppress the channel leak for the purpose of improving the presentation characteristics. Since the holding capacitor 15 can be used as the reference voltage holder of the a reverse applied voltage Vr which is supplied to a reverse applied voltage Vr supply wire 21, the WRITE characteristics for TFT17 can be stabilized and the circuitry contributes the improvement of the image quality of the image display device.

The Fourth Embodiment

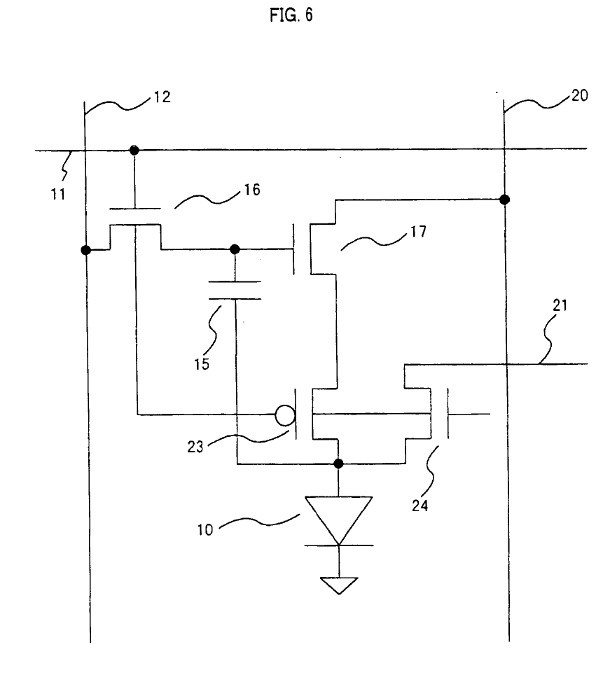

FIG. 6 shows the block diagram of an example of image display devices that realize the fourth embodiment of the present invention.

At the cross point of a scanning wire 11 and a data wire 12, a first TFT as Tsw16 for switching is formed and a signal voltage is kept in a data holding capacitor 15 when the TFT Tsw16 is selected by the signal on the scanning wire 12. The data holding capacitor 15 sets a bias voltage of a second TFT as Tdr17 and control the current flow through the second TFT Tdr17. The second TFT Tdr17 is connected to an OLED device 10 through the first bias switching TFT 23 and the OLED device 10 emits the light and displays the light spot by the current supplied through the second TFT Tdr17. To the OLED device 10, a reverse applied voltage Vr supply wire 21 is connected through the second bias switching TFT 24.

As shown in FIG. 6, the first bias switching TFT 23 is constructed with an p-channel MOS transistor and the second bias switching TFT 24 with a n-channel MOS transistor, either one of which transistors can be only “ON” by the bias control signal sent through a scanning wire 11. Therefore the voltage bias condition for the OLED device 10 can be controlled by the signal sent through the scanning wire 11.

The signal WRITE onto the picture element, the first TFT for bias switching is set OFF by the signal sent through the bias line and then signal voltage is written. The OLED device 10 emits the light and displays the light spot by setting the first TFT for bias switching ON.

On the other hand, the reverse bias is applied as described in the following; the fist TFT for bias switching is set OFF and the second TFT for bias switching is set ON then the OLED device is set in a reverse bias condition given by a reverse applied voltage Vr supply wire 21.

In the embodiment, the fist TFT Tsw16, the second TFT Tdr17 and the second bias switching TFT 24 are constructed by n-channel MOS transistors and the first bias switching TFT 23 by a p-channel transistor however the present invention is not confined in such a configuration of the transistors. For example, the configuration such that the fist TFT Tsw16, the second TFT Tdr17 and the second bias switching TFT 24 are constructed by p-channel MOS transistors, the first bias switching TFT 23 by an n-channel transistor and the polarity of the OLED device 10 is reversed allows the control to provide TRUN-ON term and reverse bias applying term for each scanning wire and serves the effect of the present invention as well.

The Fifth Embodiment

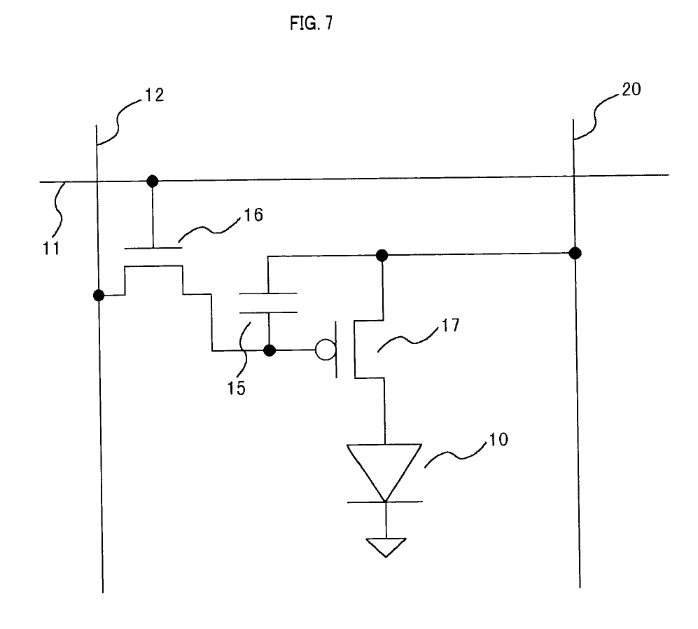

FIG. 7 is a circuit diagram of an image display device regarding to the fifth embodiment of the present invention.

The difference of this embodiment from the third embodiment features that the circuit system does not independently have a reverse applied voltage Vr supply wire 21. In other words, the circuit is designed that the electric current supply wire 20 has a capability to apply a reverse applied voltage Vr for a certain period of terms as well as current supply for the OLED device 10 and the bias switching is not carried out by the bias switching control wire 22 but the scanning wire 11. In this embodiment, since the bias switching control wire 22 has been removed, the open area of the picture element can be widened and the power consumption of the circuitry can be effectively reduced. The reduction of wire quantity can effects the improvement of the manufacturing yield.

The above description explains the effect of the present invention. In the embodiments, the timing chart (FIG. 2) of the analog driving circuit has been used for the explanation. However, the effect of the present invention is not limited into such circuit configuration. For example, the pulse width modulation (abbreviated as PWM, hereinafter) scheme where a sub-field to which quantized time width is allocated is used for this invention and it is possible to control the address term and the term of TURN-ON and TURN-OFF regarding each row of the picture elements connected to a bias voltage switching control wire 22 in a single frame term. Therefore one frame term can be effectively used for both the TRUN-ON and TRUN-OFF terms. Since the PWM method that has a plurality of sub-fields takes more access times to the picture element, the effect of the present invention becomes to be rather enhanced.

For all of these embodiments, for an image display device of active matrix type that has electric current-driven electro optic display elements, it is possible to allocate the TURN-ON term and the reverse bias applying term independently for each scanning wire to which a group of such display elements are connected. By using this scheme, it is possible to extend the life time of the image display device by decreasing the degradation of the display elements in low peak intensity operation but with allocating the long display term in one fame time.

In addition, it is possible to extend the life time of the display device by applying the reverse bias to the display device in switching the bias voltages during the address term and the voltage signal held in the memory of the picture element is stabilized and to obtain the image display devices that have sufficient picture quality.

What is claimed is:

1. An image display device comprising an electric current-driven electro optic display element and a drive circuit to control a driving current supplied to said electro optic display element on a substrate on which a plurality of picture elements is aligned in a form of a matrix wherein each picture element has a light-emitting layer that has a transparent picture element electrode and a metal picture element electrode therebetween to compose the electric current-driven electro optic display element, wherein;
each picture element has a driving circuit which is connected to a vertical scanning circuit that includes a sequential circuit through a scanning wire and to a horizontal driver through a data wire, and
either the transparent picture element electrode or the metal picture element electrode is connected to a wire placed in parallel to said scanning wire and a terminal of said wire is, through a switching device, selectively connected to an electric power source that gives an electric potential for a purpose of applying a voltage necessary to drive said electric current-driven electro optic display element or to another electric power source that gives an electric potential of which polarity is reverse to a voltage applied in emitting operation.

2. An image display device according to claim 1, wherein said switching device has a switching operation by using a sequential circuit that has a same scanning direction as a same scanning direction that said vertical scanning circuit has.

3. An image display device according to claim 1, wherein said switching device has a switching operation by using a signal generated by a sequential circuit built in said vertical scanning circuit.

4. An image display device according to claim 1, wherein either said transparent picture element electrode or said metal picture element electrode is directly or, through a driving device, connected to said wire.

5. An image display device according to claim 1, wherein;
said switching device has a switching operation by using a sequential circuit that has a same scanning direction as a same scanning direction that said vertical scanning circuit has, and
either said transparent picture element electrode or said metal picture element electrode is directly or, through a driving device, connected to said wire.

6. An image display device according to claim 1, wherein;
said switching device has a switching operation by using a signal generated by a sequential circuit built in said vertical scanning circuit, and
either said transparent picture element electrode or said metal picture element electrode is directly or, through a driving device, connected to said wire.

7. An image display device according to claim 1, wherein either said transparent picture element electrode or said metal picture element electrode is connected to said wire within each said picture element.

8. An image display device comprising an electric current-driven electro optic display element and a drive circuit to control a driving current supplied to said electro optic display element on a substrate on which a plurality of picture elements is aligned in a form of a matrix wherein each picture element has a light-emitting layer that has a transparent picture element electrode and a metal picture element electrode therebetween to compose the electric current-driven electro optic display element, wherein;
each picture element has a driving circuit which is connected to a vertical scanning circuit that includes a sequential circuit through a scanning wire and to a horizontal driver through a data wire and
either the transparent picture element electrode or the metal picture element electrode has a switching device within each said picture element of which said switching device has a function to selectively switch-on to a current source or to an electric power source that gives an electric potential which has a reverse polarity of a voltage necessary to drive said electric current-driven electro optic display element in emitting operation.

9. An image display device comprising:
a plurality of scanning wires that are distributively laid over an image display area therein and that transmit a scanning signal therethrough,
a plurality of data wires that are laid over said image display area with crossing over the plurality of the scanning wires and that transmit a signal voltage therethrough,
a plurality of electric current-driven electro optic display elements of which each element is laid in each of picture element areas surrounded by said scanning wire and said data wire and connected to a common electric power supply,
a plurality of driving devices that are connected to said electric current-driven electro optic display elements in series and to a common electric power supply and that activate said electric current-driven electro optic display elements for emission by applying bias voltage thereto, and
a plurality of memory control circuits that hold said signal voltage in response to said scanning signal and control a driving operation of said driving devices by using said signal voltage, wherein;
said memory control circuit holds a signal voltage obtained by a signal sampling with blocking the bias voltage applied to said driving device while said electric current-driven electro optic display elements are kept in a voltage status for non-emission and said signal voltage is applied to the driving device as the bias voltage thereafter.

10. An image display device according to claim 9, wherein said scanning signal is used for said control signal that change the bias voltage applied to the electric current-driven electro optic display elements in a switching manner.
